(19) United States
(12) Patent Application Publication
(10) Pub. No.: US 2014/0130334 A1
(43) Pub. Date: May 15, 2014

(54) Adjustable Holding Apparatus

(71) Applicant: James K. Chun, Bellevue, WA (US)

(72) Inventor: James K. Chun, Bellevue, WA (US)

(21) Appl. No.: 14/080,150

(22) Filed: Nov. 14, 2013

Related U.S. Application Data
(60) Provisional application No. 61/726,268, filed on Nov. 14, 2012.

(51) Int. Cl. F16M 11/04

(52) U.S. Cl. CPC F16M 11/048
USPC 29/525.01; 248/122.1

(57) ABSTRACT

A holding apparatus that includes a base with complex curved upper surface with an upward extending front arc section, a long curved incline section, and a longitudinally aligned slot formed on the upper surface. The area of the upper surface adjacent to the slot is relatively flat enabling the lower surface of a camera or an device holder disposed transversely over the base to may be perpendicular aligned with base adjacent to the bolt. The bolt is inverted with a head and a threaded shaft that extends through the slot. During assembly, an electronic device may be disposed over the top surface of the base and securely attached to the exposed end of the bolt. By moving the bolt to different positions on the slot, the electronic device may be positioned at different locations on the base and at different angles. The base may be used with an optional device holder or an extension adapter.

This utility patent application is based upon and claims the filing date benefit of U.S. provisional patent application (Application No. 61/726,268) filed on Nov. 14, 2012.

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention

This invention pertains to relatively small apparatuses for temporarily holding an electronic device, such as a camera, cell phone or MP3 player, on a support surface such as a table top that also allows the operator to easily reposition the electronic device when attached to the apparatus for optimal operation and viewing.

2. Description of the Related Art

Tripods with length adjustable legs are commonly used to hold a camera when taking pictures. The legs on the tripod are sufficiently spread apart and usually adjustable in length to securely support and hold a camera in a desired fixed, elevated position on a support surface.

Most portable electronic devices, such as cameras, cell phones, tablet computers and MP3players, have large displays that enable an operator to surf the web or to view pictures and videos from a distance. Ideally, the electronic device is placed on a flat support surface, such as a table or desk, and vicariously positioned against another object or surface so its display may be tilted rearward for optimal viewing. Optimal viewing can require the display to be placed at an angle of 15 to 110 degrees relative to the flat support surface.

The position of the electronic device needed to support the electronic device may not position the display at an angle for optimal viewing. Also, the support surface may be smooth and a slight impact or vibration may cause the electronic device to tip over. Sometimes the operator may also need to press against the display to enter a password or swipe against the display causing the electronic device to tip over.

What is needed is a portable holding apparatus for holding an electronic device directly on a flat support surface that allows the operator to adjust the angle the electronic device is held for optimal operation or viewing.

### SUMMARY OF THE INVENTION

These and other objects are met by the holding apparatus disclosed herein that is portable, has a small foot print when setup on a flat support surface, and securely holds and supports an electronic device, such as a camera, cell phone, tablet computer, or MP3 player upright and at different angles for viewing by a user. The holding apparatus includes a relatively wide, low profile base with a complex, curved top surface that includes a short upward extending front section, a curved intermediate section, and a long rear incline section. In the embodiment shown herein, the side profile of the base is wedge shaped and made of molded plastic with the front section, the intermediate section and the rear incline section being integrally formed. Formed on the base is a centrally located, longitudinally aligned elongated slot.

The front section has a lower front edge that rest on a support surface. The front section then extends vertically upward to form the intermediate section. The base is made of thin rectangular plate structure that curves upward and rearward forming an archway. The tail or rear section of the base extends rearward to support an electronic device tilted rearward and attached to the base. The inside surface of the rear inclined section is substantially flat and designed to rest against a flat support surface.

Inserted into the slot is an inverted slide bolt. The bolt includes a wide head which after assembly is positioned against the inside surface of the base. The slot extends at least partially into the front arc section, across the intermediate section and then into the rear incline section.

During assembly, the bolt is inverted and aligned over the slot so the threaded shaft extends through the slot and above the base's top surface. The exposed portion of the threaded shaft may be directly attached to the internal threads on the mounting bore on a camera, to the mounting bore on an electronic holding device or to an extension adapter. The shaft of the bolt is sufficient in size to allow it to slide freely in a fore-to-aft or aft-to-fore direction while still retained inside the slot. A lock washer is installed around the section of the threaded shaft that extends the slot that holds the bolt inside the slot when not attached to an electronic device, electronic holder or an extension adapter. During use, the bolt is moved to a desired location that holds the electronic device in an optimal angle on the support surface. The head of the bolt is tightened to hold the bolt in the slot.

Also shown herein the base may be used with two optional electronic holders or with an extension adapter.

### BRIEF DESCRIPTION OF THE DRAWINGS

FIG. 1 is a top perspective view of the holding apparatus.

FIG. 2 is a bottom perspective view of the holding apparatus.

FIG. 3 is a top plan view of the holding apparatus.

FIG. 4 is a bottom plan view of the holding apparatus.

FIG. 5 is a right side elevational view of the holding apparatus.

FIG. 6 is a left side elevational view of the holding apparatus.

FIG. 7 is front elevational view of the holding apparatus.

FIG. 8 is a rear elevational view of the holding apparatus.

FIG. 9 is a left side elevation view of the base, a device holder with multiple rotating arms shown in an expanded configuration attached to the base, and holding an electronic device in landscape orientation, and showing placing an optional extension adapter attached to the base.

FIG. 10 is a front elevational view of the base, the device holder and the electronic device shown in FIG. 9.

FIG. 11 is a rear elevational view of the base, the device holder and the electronic device shown in FIG. 9.

FIG. 12 is a sectional, side elevational view of the base showing how a rigid support on the device holder or adapter slides along the slot and may be repositioned on the base.

FIG. 13 is a front perspective view of the device holder with multiple rotating arms showing the arms in a collapsed configuration

FIG. 14 is a rear perspective view of the device holder in a collapsed configuration.

FIG. 15 is a side elevational view of the device holder in a collapsed configuration.

FIG. 16 is a front elevational view of the device holder in a collapsed configuration.

FIG. 17 is a front perspective view of the base with second device holder that uses a rigid post and two length adjustable clamping aims expanded and holding an electronic device in landscape orientation.

FIG. 18 is a front elevational view of the second device holder with a rigid post and two length adjustable clamping arms expanded and in landscape orientation.

FIG. 19 is a rear elevational view of the second device holder shown in FIG. 18.

FIG. 20 is a front perspective view of the base with second device holder that uses a rigid post and two length adjustable clamping arms and holding an electronic device collapsed and in portrait orientation.

FIG. 21 is a front perspective view of the base with second device holder that uses a rigid post and two length adjustable clamping arms and holding an electronic device in portrait orientation.

FIG. 22 is a front elevational view of the second device holder with a rigid post and two length adjustable clamping arms in portrait orientation.

FIG. 23 is a front perspective view of the base with second device holder that uses a rigid post and two length adjustable clamping arms showing the clamping arms vertically aligned and in a closed configuration.

FIG. 24 is a front elevational view of the second device holder shown in FIG. 23.

FIG. 25 is a side elevational view of the second device holder shown in FIGS. 23 and 24.

FIG. 26 is a side elevational view of the second device holder showing the clamping arms collapsed and horizontally aligned.

FIG. 27 is a top plan view of the second device holder shown in FIG. 26.

FIG. 28 is a bottom plan view of the second device holder shown in FIGS. 25 and 26.

FIG. 29 is a perspective view of the base with an extension adapter attached thereto.

FIG. 30 is a side elevational view of the base with the extension adapter shown in FIG. 29.

FIG. 31 is a top, front perspective view of the extension adapter.

FIG. 32 is a bottom rear perspective view of the extension adapter shown in FIG. 31.

FIG. 33 is a left side elevational view of the extension adapter.

FIG. 34 is a right side elevational view of the extension adapter.

FIG. 35 is a top plan view of the extension adapter.

FIG. 36 is a bottom plan view of the extension adapter.

### DESCRIPTION OF THE PREFERRED EMBODIMENT(S)

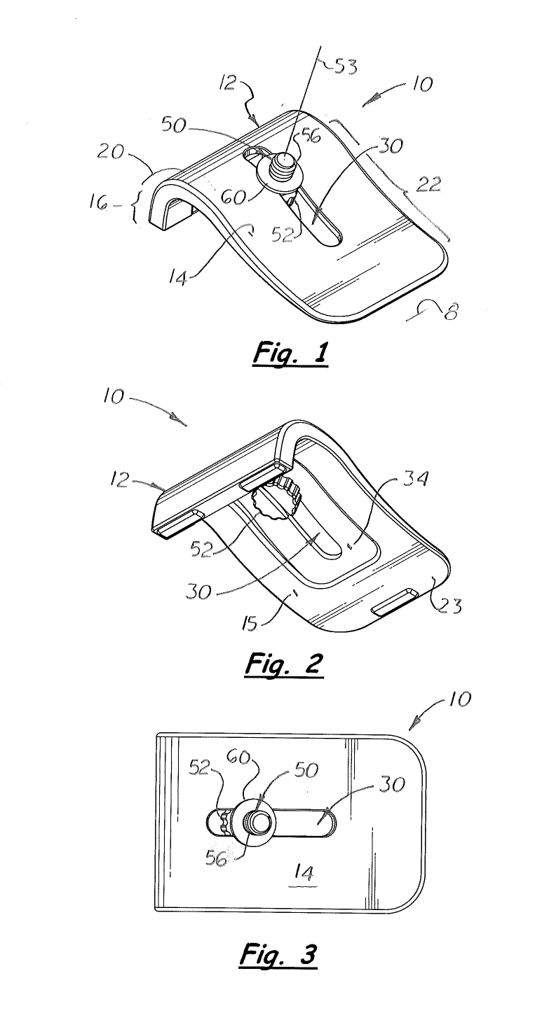

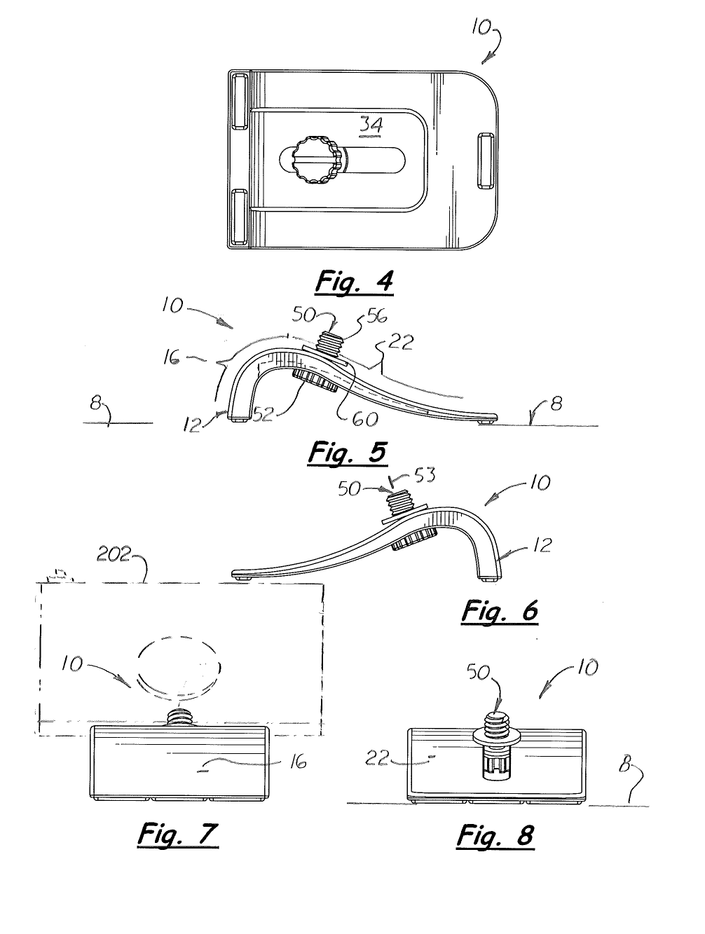

Referring to the accompanying FIGS. 1-8, a holding apparatus 10 is shown that includes a base 12 with complex curved top surface 14 that has an upward extending short front section 16, an curved intermediate section 20, and a long concave curved rear incline section 22. Formed on the base 12 is a central, longitudinally aligned slot 30 that extends continuously from the convex curved intermediate section 20 and a substantially into the rear inclined section 22. The lateral areas of the top surface 14 adjacent to the slot 30 are relatively straight and aligned thereby enabling the lower surface of an electronic device 200, such as a camera, cell phone, tablet computer or MP3 player to be extended across and supported thereon.

The holding apparatus 10 also includes an inverted bolt 50 with a head 52 and thread shaft 56. During assembly, the head 52 is positioned against the bottom surface 15 on the base 12 and the shaft 56 is extended through and slides freely along the slot 30. A lock washer 60 is placed around the shaft 56 to hold the shaft 56 on the slot 30 and the base 12. The shaft 56 is configured to slide freely inside the slot 30 which allows it to slide to different positions on the base 12. By moving the bolt 50 to different positions on the slot, the angle or orientation of the bolt 50 may be changed When the bolt 50 is tightened against the inside surface 14 of the base 12, the longitudinally axis 53 of the bolt 50 is at the same angle of an axis line perpendicular to the surrounding curvature of the base 12 where the shaft 56 of the bolt 50. Because the curvature of the top surface 14 of the base 12 changes, the viewing angle of an electronic device 200 attached to the bolt 50 and disposed transversely over the top surface 14 of the base 12 may be changed by sliding the bolt 50 to different locations on the slot 30. The bolt 50 is then tightened to hold the electronic device 200 in a locked position on the base 12.

As shown in FIGS. 5 and 6, the base 12 has a wide, low side profile that is wedge-shaped. The base 12 measures 4.4 mm in width, 6.7 mm in length. The height maximum height of the intermediate section 20 is approx. 1.9 mm. The slot 30 is 30 mm in length and 6 mm in width. The rear incline section 22 extends upward at an angle of 15 to 30 degrees from the support surface 8 and terminates at the intermediate section 20. The front edge 17 of the base 12 is flat and positioned on a support surface 8 during use. The distal end of the bottom surface 23 of the rear incline section 22 is flat and rests against the support surface 8.

As stated above, the base 12 is designed to be used with various electronic device 200 that includes a threaded mounting bore on its lower surface configured to attach to a standard camera tripod bolt. Bolt 50 is similar to the bolt commonly used on a camera tripod. The base 12 may however, be attached to other intermediate structures used to hold an electronic device 200.

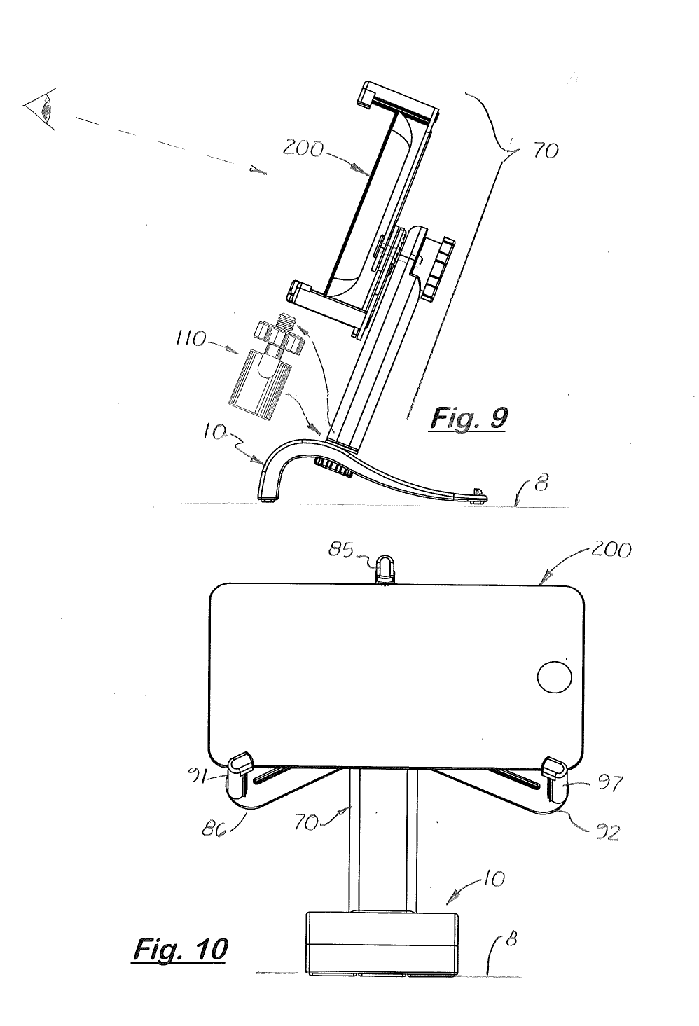

For example, FIGS. 9-11 show an adjustable device holder 70 attached to the base 10. An electronic device 200, may be held by the device holder 70 that allows the electronic device 200 to be oriented in a landscape or portrait mode. The device holder 70 includes a rigid post 72 with at least to arm that hold an electronic device 200. In the embodiment shown, the holder 70 has three rotating arms 80, 86, and 92 mounted to a threaded pin 74 that extends transversely through the upper end of the post 72. The upper end of the post 72 includes a recessed cavity in which a threaded nut 78 is inserted and attaches to the threaded pin 74. When the threaded nut 78 is tightened on the threaded pin 74, the head of the pin 74 is forced inward and presses the arms 80, 86, 92 together to hold them in position to hold the electronic device 200. Formed on the lower end of the rigid post 762 is a threaded bore 75 that connects to post 57 or 128.

Each arm 80, 86, 92, is L-shaped with a perpendicularly aligned outer leg 84, 90, and 96. Mounted or formed on each leg 84, 90, 96 is an optional perpendicular aligned foot, 85, 91, 97, respectively. Each arm 80, 86, 92 also includes an optional elongated slot 82, 88, 96, that allows each arm 80, 90, 92 to slide inward or outward from the pin 76 and thereby decrease or increase its length.

FIG. 12 is a sectional, side elevational view of the base 12 showing how the device holder 70 or intermediate member 112 (described further below) slides over the base 12 and is repositioned

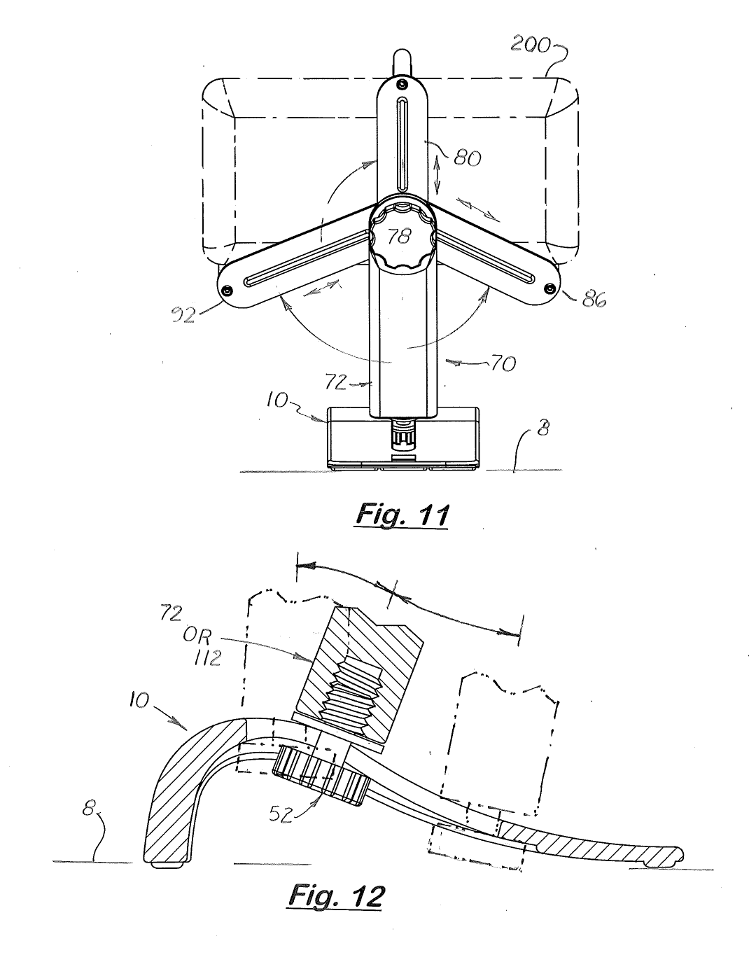

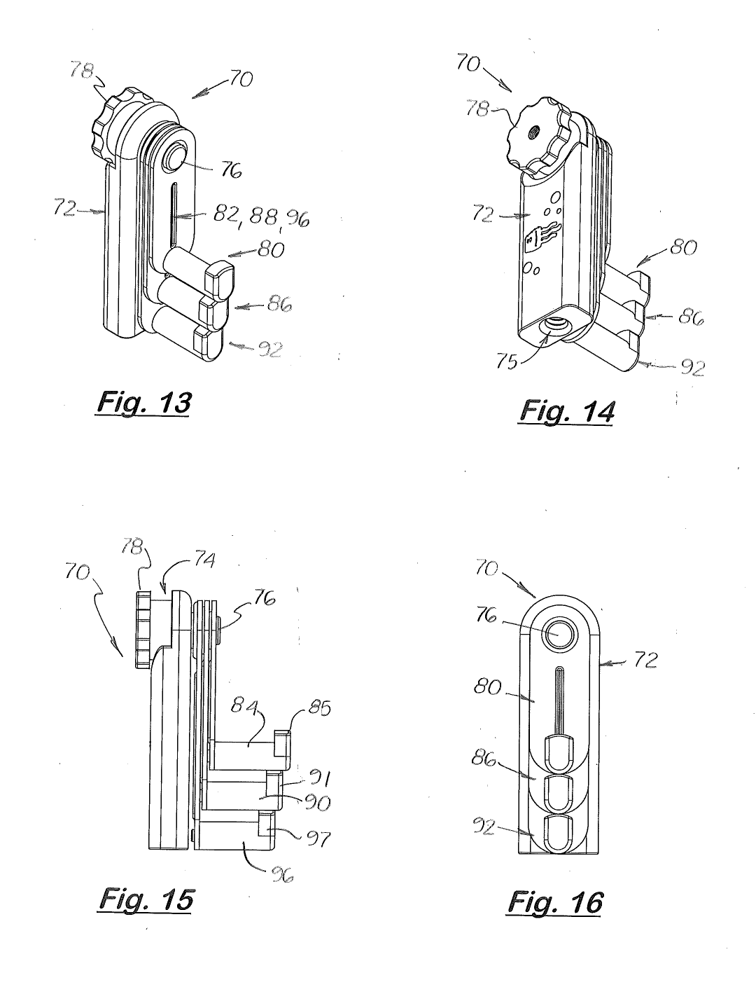

FIGS. 13-16 are front perspective, rear perspective, side elevational, and front elevational views of the device holder 70 detached from the base 10 and shown in stacked, collapsed configuration. FIGS. 11 and 14 show the device holder 70 with the arms 80, 86, and 92 radially aligned around the post 72.

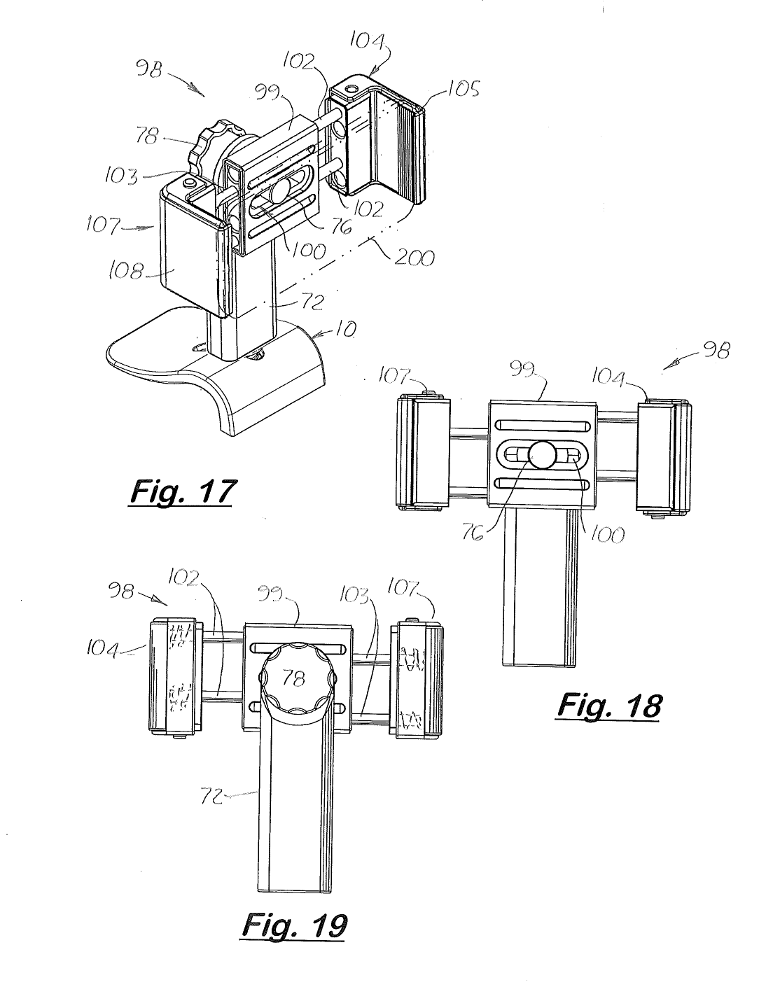

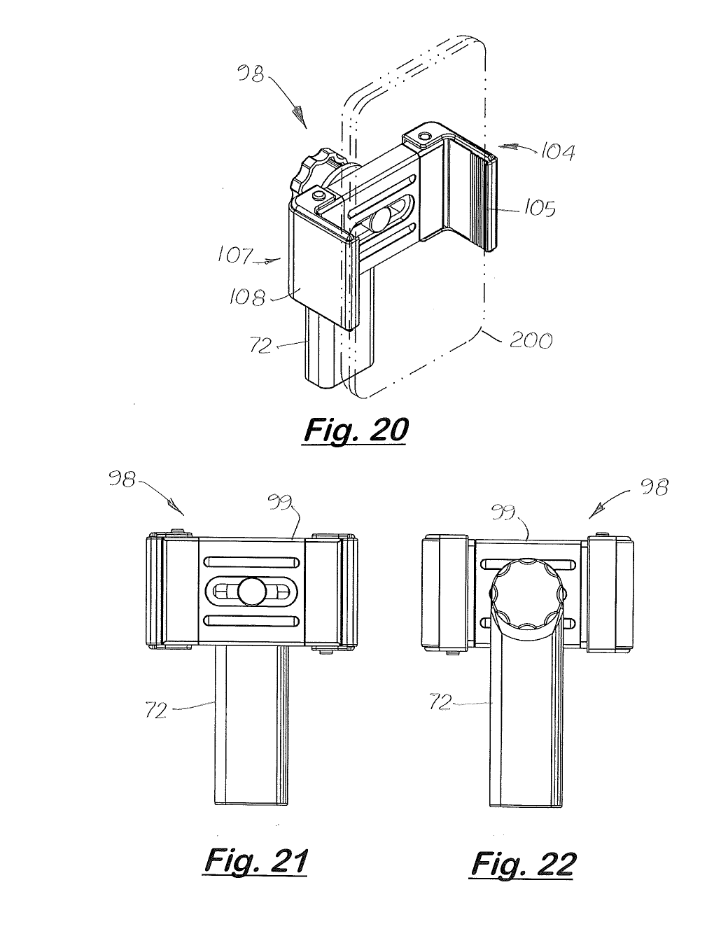

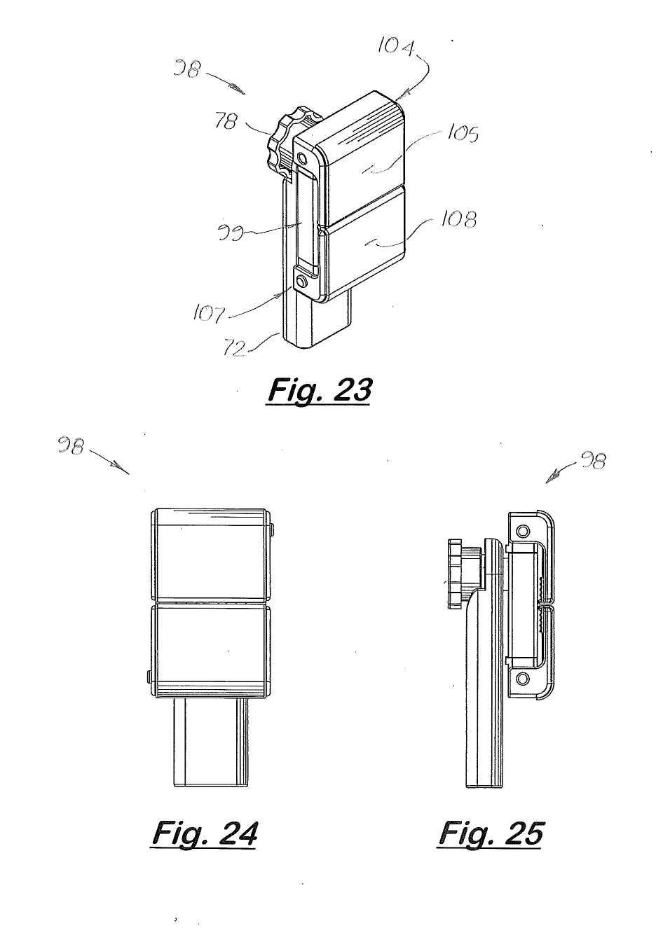

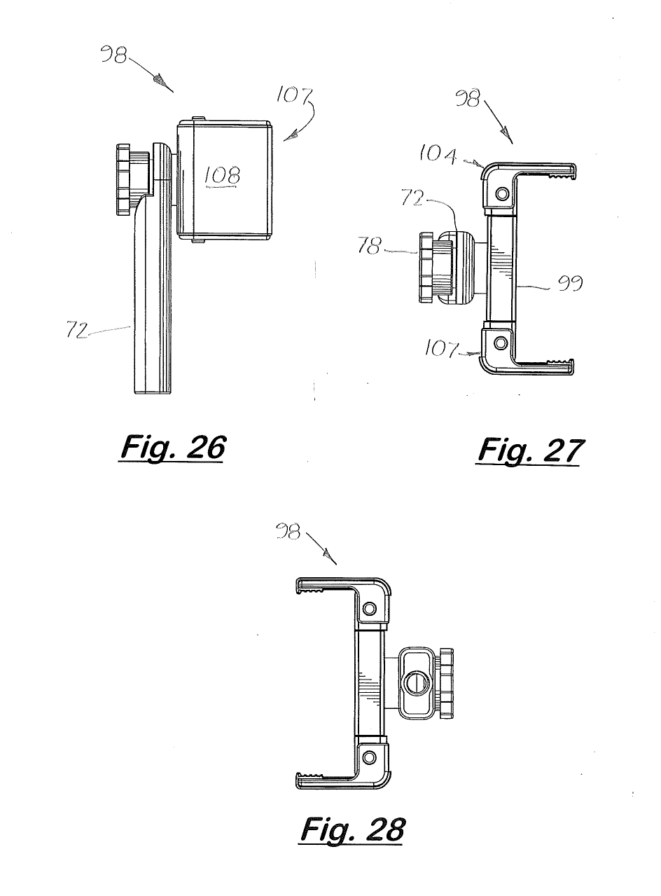

FIGS. 17-28 show a second device holder 98 that uses a rigid post 72 and two length adjustable clamping arms 104, 107 expanded and holding an electronic device in landscape or portrait orientations. The lengths of the arms 104, 107 may be adjusted to allow the device holder 98 to be used with different size electronic device 200. The arms 104, 107 may also be close for compact storage with not in use as shown in FIG. 23-25.

More specifically, the second device holder 98 and rotating center spacer 99 with a slot 100. Extending through the slot 100 is a pin 76 that connects to the nut 78. Extending from the opposite ends of the space 99 are two pairs of spring loaded rods 102, 103 that connect to the two arms 104, 107. The rods 102, 103 bias the arms 104, 107 inward. Attached to each arm 104, 107 are perpendicularly aligned end plates 105, 108.

During use, the space 99 may rotate 360 degrees around the pin 76 which allows the arms 104, 107 to be horizontally aligned as shown in FIGS. 17-22 or vertically aligned as shown in FIGS. 23-25. The end plates 105 108, are pivotally attached enabling them to folded inward as shown in FIGS. 23-25

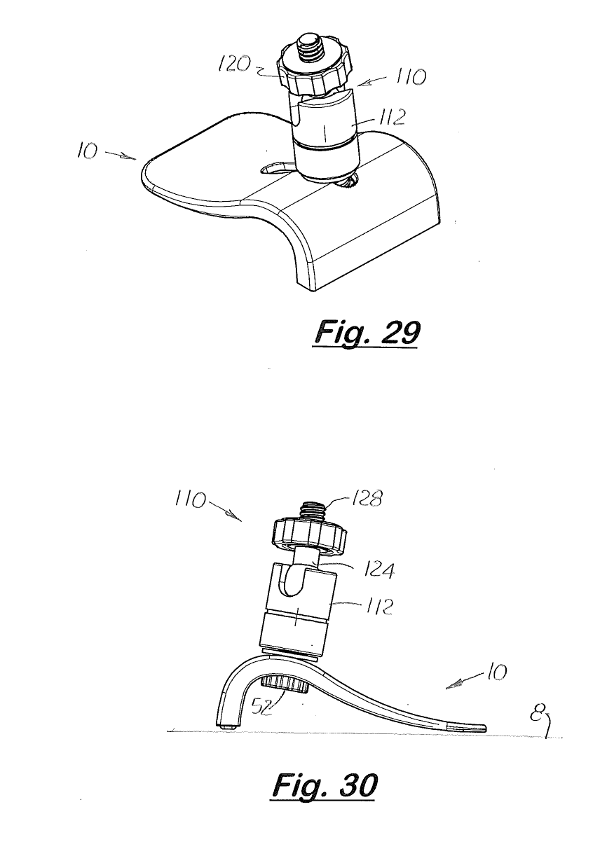

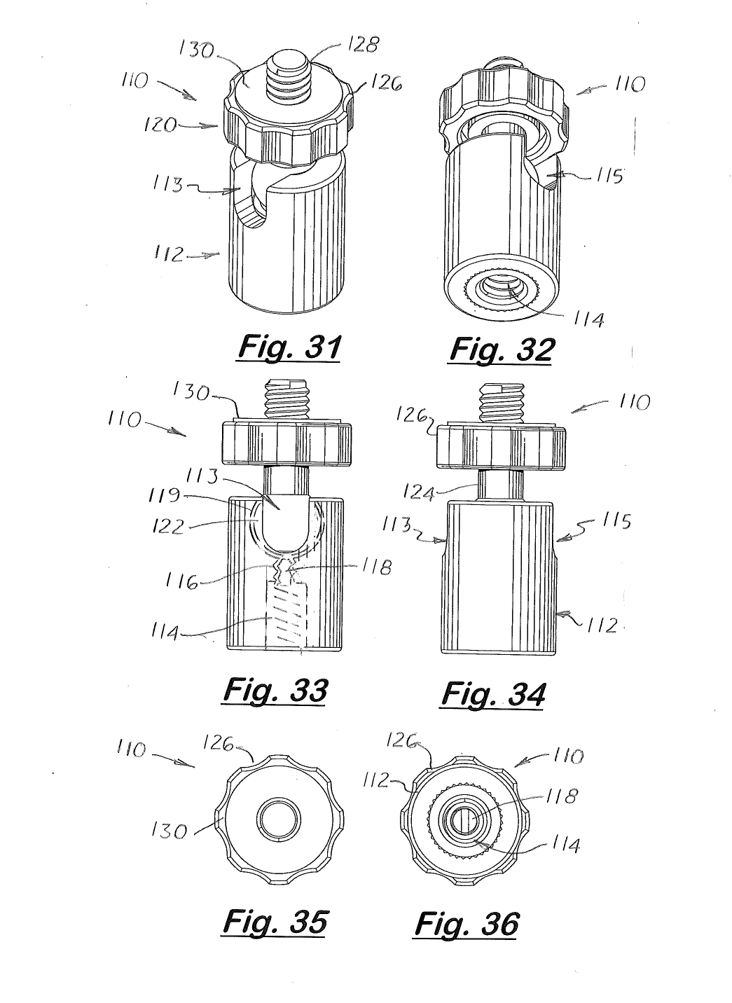

FIGS. 29 and 30 show the base 12 used with an extension adapter 110 that elevates the electronic device 200 above the base 12 and includes an adjustable ball connector 120 that allows the user to fine tune the viewing angle of the electronic device 200 over the base 12. As shown in FIGS. 31-36, the extension adapter 110 includes a lower cylindrical body 112 with two side slots 113, 115, and a longitudinally aligned lower threaded bore 114. Formed inside the body 112 is an upper spherical void 116. The two side slots 113, 115 extend inward and communicate with the spherical void. Extending from the upper end of the threaded bore 114 is a longitudinally aligned, small diameter threaded bore 116 in which a threaded screw 118 is inserted. The tip of the threaded screw 118 extends into the spherical void 116 and presses against the spherical member 122 attached to the ball connector 120 after assembly.

The ball connector 120 includes a spherical member 122 connected or mounted to an post 124. Mounted on the end of the post 124 is a nut 126. Extending upward from the top surface of the nut 126 is a longitudinally aligned threaded post 128. Disposed around the threaded post 128 is a washer 130.

Also disclosed herein is a method for holding an electronic device 200 on a support surface 8 using a base 12 with a complex curve top surface 20 and a longitudinally aligned slot 30 congruent with the surface 20 and a bolt 50 moveable along the slot 30 and extending upward therethrough and locked in a fixed position on the base 12, the method comprising the step of:

a. coupling the electronic device 200 to the end of the bolt 50 that extends through the slot 30 formed on the base 12; and,

b. sliding the bolt 50 along the slot 30 along the upper surface 20 to position the electronic device 200 at a desired viewing or operational angle and then tightening the bolt 50 on the base 12 to hold the electronic device 200 at a fixed position on the base 10.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. An adjustable holding apparatus, comprising;
a. a wedge-shaped base configured to support a device with a display selectively positioned by a viewer for optimally viewing of manual operation, the base includes an upward extending front arc section and a downward inclined, rear curve section that extends downward from the front arc section
b. a slot longitudinally aligned on the base extending from the front arc section to the rear curve section, the slot being congruent with the front arc section and the rear curve section; and,
c. a bolt configured to slide longitudinally along the slot and selectively set in a locked position on the base, the bolt includes a shaft that extends above the slot and engages a device positioned above the bolt and transversely aligned over the front arc section or rear curve section on the base.

2. The holding apparatus as recited in claim 1 wherein the bolt includes a threaded shaft that engages a aid inclined surface is a curved surface.

3. The holding apparatus as recited in claim 1, wherein the incline surface includes at least to curve sections forming an irregular complex curved surface.

4. The holding apparatus as recited in claim 1, wherein the base includes a front edge that extends downward from the upward extending arc section configured to support the base on a support surface.

5. The holding apparatus as recited in claim 1, wherein the base includes a rear support structure formed or attached to a distal end of the incline surface configured to support the base on a support surface.

6. The holding apparatus as recited in claim 1, wherein the base has a side profile that is s-shaped.

7. The holding apparatus as recited in claim 1, further including a rigid support arm perpendicularly aligned with the upper surface of the base and attached to the threaded shaft.

8. The holding apparatus as recited in claim 1, further including a device holding cradle attached an end of the support arm opposite the base.

9. The holding apparatus as recited in claim 1, wherein said cradle is adjustable to hold different sizes of device.

10. The holding apparatus as recited in claim, wherein said base is single planar structure that forms a lower front edge, an upper arc section formed above the front edge, a lower incline section integrally formed with the upper arc section and a rear support edge.

11. A holding apparatus, comprising:
a. a base with an upward extending, arching top surface, the top surface being configured to support a viewing device transversely aligned over the top surface, and;
b. a connector that can be repositioned and set at a fixed position on the base and configured to attach to a viewing device transversely aligned over the top surface.

12. The holding apparatus, as recited in claim 11, wherein the connector is a threaded bolt that slides in a slot formed on the base and configured to attach to the viewing device.

13. The holding apparatus, as recited in claim 11 wherein the base includes an upward extending front arc section and a rear incline section integrally formed with the front arc section.

14. The holding apparatus, as recited in claim 12, further including the base including a front edge and a rear edge and a raised archway formed under the base.

15. A method for holding a camera or cell phone on a flat support surface using a holder with a complex curve upper surface and a longitudinally aligned slot congruent with the upper surface and a bolt moveable along the slot and extending upward therethrough and locked in a fixed position on the base, the method comprising the step of:
a. coupling the camera or cell phone to the end of the bolt that extends through the slot; and,
b. sliding the bolt along the slot and camera or cell phone base along the upper surface to position the camera or cell phone at a desired angle and then tightening the bolt on the base to hold the camera and cell phone at a fixed position on the base.
